(19) United States
(12) Patent Application Publication
(10) Pub. No.: US 2002/0073029 A1
(43) Pub. Date: Jun. 13, 2002

(54) System and method of authorizing an electronic commerce transaction

(75) Inventors: Daniela Cheaib, Cartierville (CA); Roch Glitho, Montreal (CA)

Correspondence Address: ERICSSON RESEARCH CANADA, 8400 DECARIE BLVD., MONTREAL, QC, H4P 2N2, CA

(73) Assignee: Telefonaktiebolaget LM Ericsson (publ)

(21) Appl. No.: 09/735,568

(22) Filed: Dec. 12, 2000

(51) Int. Cl. G06F 17/60

(52) U.S. Cl. 705/41; 705/26; 382/229

(57) ABSTRACT

A system and method of authorizing an electronic commerce transaction between a purchaser using a credit card, an on-line merchant, and a credit card company. A server associated with the merchant receives a purchase request from the purchaser that includes a purchase amount and the purchaser's credit card information. A SIP multi-party conference is established, and information is shared among the three parties through a multicast procedure. A Web camera may take an image of the purchaser when the purchaser sends the purchase request to the merchant. A whiteboard application is used to capture an image of the purchaser's signature. The credit card company verifies the credit card information, authorizes the purchase amount, and validates the purchaser's image and signature utilizing an image recognition program and a database of valid cardholder images and signatures.

### BACKGROUND OF THE INVENTION

1. Technical Field of the Invention

This invention relates to electronic commerce and, more particularly, to a system and method of authorizing an electronic commerce transaction.

2. Description of Related Art

Electronic commerce, the buying and selling of goods and services over the Internet, is changing the way business is done. Unfortunately, online payment remains a major area of Internet immaturity. For companies selling goods and services over the Internet, credit transactions are still a major risk. Credit card company figures show that while 90 percent of consumers are reimbursed when their cards are used fraudulently, 75 percent of online retailers must bear the cost themselves when they are the victims of credit card fraud.

Research in the prevention of credit card fraud has focused so far on developing methods of transmitting credit card information (e.g., credit card numbers) in a secure manner over the Internet in order to avoid eavesdroppers. Numerous protocols have been designed for this. However, while the credit card information may be transmitted securely over the Internet, there is still a fundamental problem that is not solved. The problem is that there is no guarantee that the person making the purchase is the valid owner of the credit card. Since the on-line merchant never sees the purchaser during an electronic transaction, it is a simple task for an unauthorized person to enter the valid cardholder's credit card number and expiration date, and make a purchase over the Internet.

Much of the problem stems from the fact that the payment protocols for credit cards and debit cards were originally intended for face-to-face transactions in which the purchaser is physically present with the merchant. In such face-to-face sales transactions, the merchant can see the purchaser, and may request that the purchaser show a picture ID for comparison if there is not full trust. In addition, the merchant can compare the purchaser's signature on the credit card slip with the signature on the back of the card. Neither of these methods can be used today in electronic commerce.

It would be advantageous to have a system and method of authorizing electronic commerce transactions that overcomes the disadvantages of existing solutions. Such a system and method would offer higher security and deter attempted credit card fraud. The present invention provides such a system and method.

### SUMMARY OF THE INVENTION

In one aspect, the present invention is a method of authorizing an electronic commerce transaction between a purchaser using a credit card, an on-line merchant, and a credit card company. The method begins when the merchant receives a purchase request from the purchaser. The request may include credit card information and/or a purchase amount. If the purchaser has purchased from the merchant before, the merchant may have stored the credit card information from the previous purchase in a purchaser database. A multi-party data session is then established between the purchaser, the on-line merchant, and the credit card company. This is followed by verifying the credit card information by the credit card company, taking an image of the purchaser with a Web camera, and validating the purchaser's image by the credit card company using an image recognition program and a database of processed valid cardholder images. The method may also utilize a whiteboard application to obtain the purchaser's signature. The purchaser's signature is validated by the credit card company using an image recognition program and a database of processed valid cardholder signatures. The transaction is approved upon positively verifying the credit card information and validating the purchaser's image and signature.

In another aspect, the present invention is a system for authorizing an electronic commerce transaction between a purchaser using a credit card, an on-line merchant, and a credit card company. The system includes a server associated with the merchant for receiving a purchase request from the purchaser. Credit card information may be obtained from the purchaser or from a database maintained by the merchant. A packet data network connects the purchaser, the merchant, and the credit card company in a multi-party data session. A Web camera is used to take an image of the purchaser in response to the purchaser sending the purchase request to the merchant. The system also includes a first database that stores valid credit card information that is compared to the purchaser's credit card information to verify the purchaser's information. A second database stores images of valid cardholders that are compared to the image of the purchaser to validate the purchaser's image. The credit card company approves the transaction upon positively verifying the credit card information, and upon validating the purchaser's image.

In yet another aspect, the present invention is a method of authorizing a face-to-face commercial transaction between a purchaser using a credit card and a merchant. The method begins when the merchant receives a purchase request from the purchaser that includes credit card information. This is followed by establishing a data link between the merchant and a credit card company, sending the credit card information to the credit card company, and verifying the credit card information by the credit card company. A Web camera is then used to take an image of the purchaser. This is followed by validating the purchaser's image; and approving the transaction by the credit card company upon positively verifying the credit card information and validating the purchaser's image.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of the preferred embodiment of the system of the present invention;

FIGS. 2A-2B are portions of a flow chart illustrating the steps of the preferred embodiment of the method of the present invention; and

FIG. 3 is a signaling diagram illustrating the flow of messages between the parties in an electronic transaction when performing the preferred embodiment of the method of the present invention.

### DETAILED DESCRIPTION OF EMBODIMENTS

The preferred embodiment of the present invention uses a packet data protocol such as the Session Initiation Protocol (SIP), image recognition software, and an electronic whiteboard to provide secure credit card validation in electronic commerce transactions. The invention can also automate the cumbersome and sometimes awkward procedure used today (i.e., identification verification and signature comparison) for validating credit cards during face-to-face transactions. The invention provides a secure way to purchase products over the Internet by ensuring that the purchaser signs, and that the purchaser is who he/she claims to be.

The preferred embodiment described herein utilizes image recognition software to compare an image taken of the purchaser at the time of the purchase with an image of the valid cardholder that is stored in an image database. The image recognition software is also used to compare an image of the purchaser's signature obtained through a whiteboard application with an image of the valid cardholder's signature that is stored in a signature image database. It should be recognized, however, that other identity information can also be compared, and other comparison mechanisms can be used, and still fall within the scope of the present invention. For example, electronic signatures can be compared, or a fingerprint image can be taken of the purchaser and compared to the valid cardholder's fingerprint image. Likewise, retinal scans or other biometric information can be compared. Depending on the information being compared, one or more databases may be utilized for the comparisons.

The preferred embodiment of the present invention requires that cardholders who are interested in using the system provide a sample image of themselves to the credit card company. This is in addition to the sample signature that is given today. It also requires that the site from which the purchaser conducts the transaction be equipped with a Web camera and a digital pen.

The preferred embodiment of the present invention is based on multiple standards.

1. The Session Initiation Protocol (SIP) is used to initiate a multi-party data session, although the invention is not limited to SIP, and other packet data protocols may be utilized in other embodiments.

2. The Session Description Protocol (SDP) is used to describe multimedia sessions for the purpose of session announcement, session invitation, and other forms of multimedia session initiation.

3. The Real Time Protocol (RTP) is used to provide end-to-end network transport functions suitable for applications transmitting real-time data such as audio, video, or simulation data over multicast or unicast network services. RTP provides support for content identification, timing reconstruction, loss detection, and security.

In networks that communicate between nodes utilizing the Internet Protocol (IP), message data is divided into a plurality of data packets, each having an identifying header that includes a source and destination address for the packet. The packets are then transmitted from the source to the destination through a plurality of routers in a connectionless packet-switched network. Additionally, the packets may be addressed to a plurality of destinations, and the packets are accordingly routed to each of the destinations.

The present invention uses a procedure known as multicasting to simultaneously connect a purchaser, an on-line merchant, and a credit card company in a multiparty call. Multicast is a datagram network protocol that enables an application to place a single packet on a network and have that packet transported to multiple recipients. With multicast and IPv4, the packet is sent to a multicast group, which is simply an IP address that falls into IP class D (224.0.0.0 through 239.255.255.255). Recipients express an interest in receiving packets addressed to a particular multicast group. When sending a packet to the multicast group, a client inserts a packet into the network with the appropriate target address. The packet is then picked up by any host that is interested in that group.

The invention may be implemented using, for example, the following types of programs:

1. SIP Client. All parties must run a client program such as a SIP Client program that enables them to receive multiple SIP calls.

2. Motion Pictures Experts Group-7 (MPEG-7) software. MPEG is a series of international hardware and software standards designed to reduce the storage requirements of digital video. In the present invention, MPEG-7 reference software is used to make low-level comparisons like color histogram, color layout, region shape, and contour shape using one image as an input and searching a database of images to find and display the best matches.

3. Image Recognition Program. The present invention uses an image recognition software program to compare a reference image of the cardholder's face with an image of the purchaser's face taken by the Web camera at the time of the transaction. In the preferred embodiment, a program developed by Ericsson known as Visual Search is utilized, although other commercially available image recognition software programs may be used. The reference image is symbolically decomposed to generate image grammar which is stored in an image database. The current purchaser's image is then symbolically decomposed to generate image grammar which is compared with the stored grammar of the reference image. A score above a predetermined threshold level indicates a match.

The same image recognition software may also be utilized to compare a reference image of the cardholder's signature with a signature obtained from the purchaser with a whiteboard application at the time of the transaction. Once again, the reference image is symbolically decomposed to generate image grammar which is stored in a signature image database. The current purchaser's signature is then symbolically decomposed to generate image grammar which is compared with the stored grammar of the reference signature image. A score above a predetermined threshold level indicates a match.

4. Video Tool. A video conferencing tool is used to provide Multicast backbone (Mbone) video communications. The video conferencing tool enables groups of users to transmit video to each other over an IP multicast network. A host must be equipped with a camera and frame digitizer to send video, but no special hardware is required to receive and display it. Audio is handled by a separate application.

5. Audio Tool. An optional audio tool may be used to transmit and receive audio data during the multicast communication. In some audio applications, the audio and video data can be handled in a single window. For the audio, most systems do not require any hardware other than a microphone since the sound input/output (I/O) is via the built-in audio hardware.

6. Whiteboard. The preferred embodiment utilizes a unicast and multicast shared whiteboard application. A whiteboard application enables parties to share images, text, and data. Multiple users can simultaneously view and annotate a document with pens, highlighters, and drawing tools. The whiteboard application enables the purchaser to sign the whiteboard, and the signature image is shared with the merchant and the credit card company. Each of the parties can then save and/or print the image.

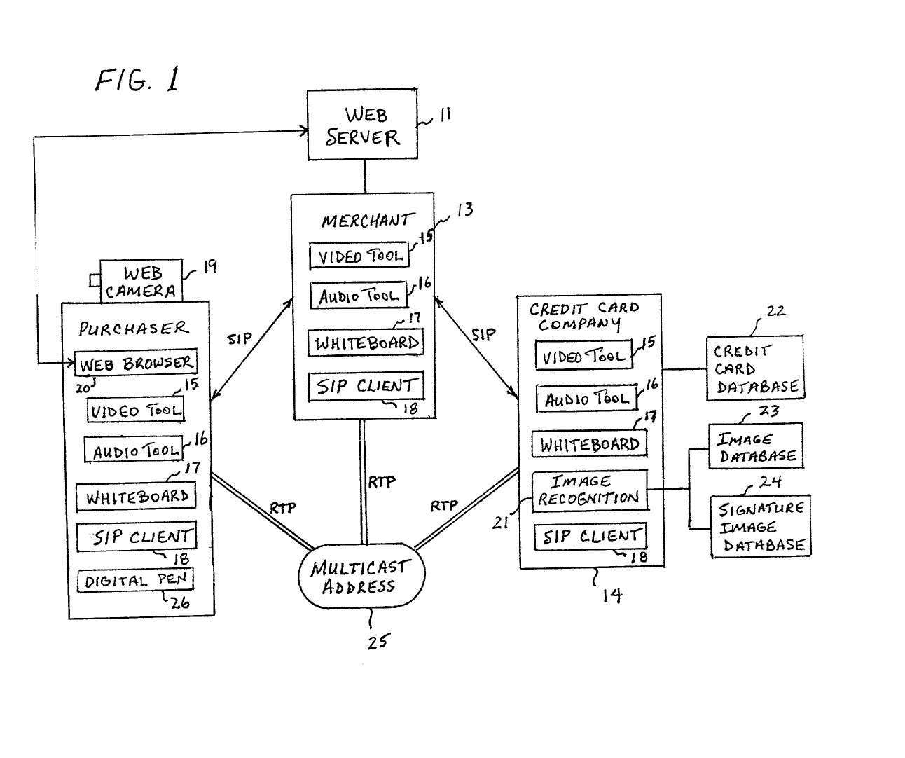

FIG. 1 is a simplified block diagram of the preferred embodiment of the system of the present invention. The system includes a Web server 11, and three participating parties: a Purchaser 12, an On-line Merchant 13, and a Credit Card Company 14. All three of the parties' sites have a video conferencing tool 15, an optional audio tool 16, and a whiteboard application 17 installed, as well as a client program which may be, for example, a SIP client 18. The Purchaser site 12 also includes a Web camera 19, a digital pen 26, and a Web browser 20 that the Purchaser uses to shop on-line with the Merchant 13 through the Web server 11.

The Credit Card Company site 14 also includes or has access to an image recognition program 21 such as Visual Search developed by Ericsson. The Credit Card Company site also includes or has access to one or more databases. A database of credit card information 22 contains such information as card numbers, cardholder names and addresses, expiration dates, credit limits, available credit, and account status. This database is used to verify the credit card information submitted by the purchaser and to authorize the purchase amount. An image database 23 includes image grammar from symbolically decomposed reference images of valid cardholders. Since there may be more than one valid user of a given credit card, the database may contain multiple reference images for a single credit card. A signature image database 24 includes image grammar from symbolically decomposed reference images of the signatures of valid cardholders. Once again, more than one signature reference image may be stored for a single credit card. The databases may be implemented as a single database of valid cardholder information.

When the Purchaser submits a purchase request to the on-line Merchant, the Merchant initiates a multiparty SIP session in which each of the three sites uses a multicast IP address 25 to send and receive data from the other sites.

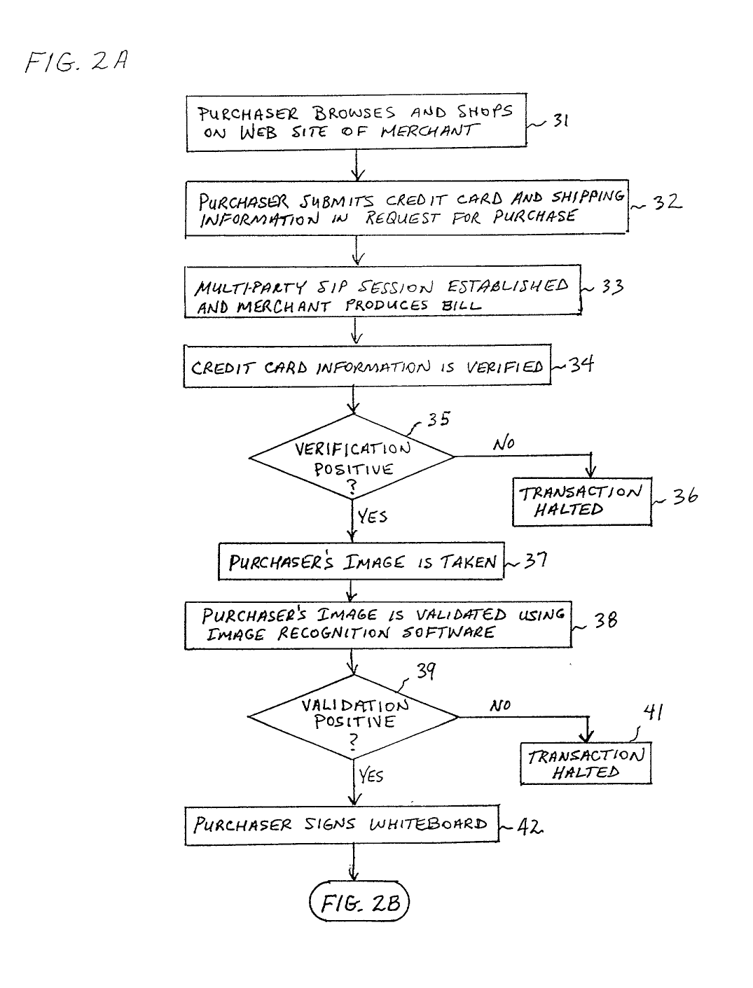

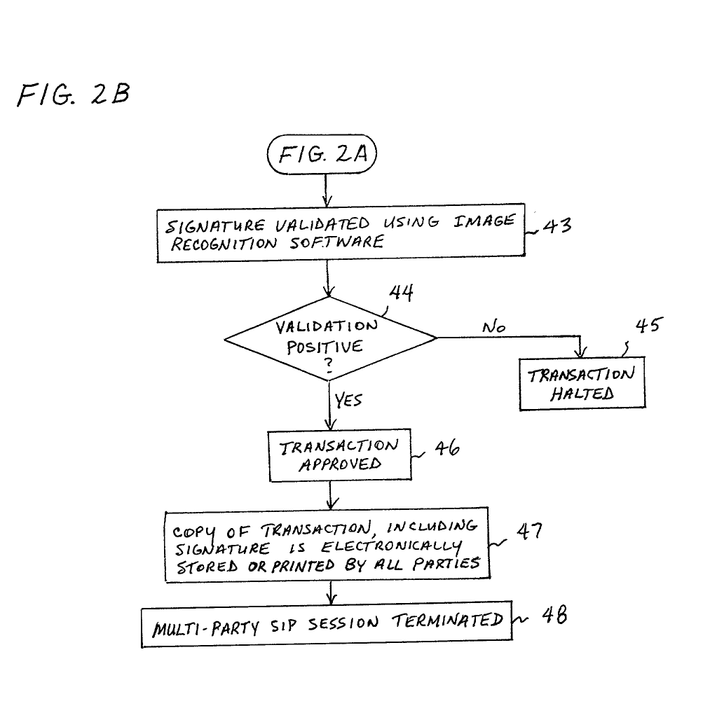

FIGS. 2A-2B are portions of a flow chart illustrating the steps of the preferred embodiment of the method of the present invention. At step 31, the Purchaser browses and shops on the Web site of the online Merchant. When the Purchaser finishes shopping at 32, a purchase request is submitted by secure protocol such as Secure Socket Layer (SSL). The purchase request may optionally include the amount of the purchase, credit card information, and the purchaser's shipping information. If the purchaser has purchased from the merchant before, the merchant may have stored the credit card information from the previous purchase in a purchaser database. At 33, a multi-party SIP session is then established between the Purchaser, the on-line Merchant, and the Credit Card Company using a SIP multiparty setup tool, and the Merchant produces a bill in the multi-party SIP Session that includes the purchaser's credit card information and the purchase amount.

At step 34, the purchaser's credit card information is verified, and the purchase amount is authorized, using normal procedures. At step 35, it is determined whether or not a positive verification of the credit card information and purchase amount was achieved. If not, the method moves to step 36 where the transaction is halted. If the verification was positive, the method moves to step 37 where the credit card company directs the Web camera at the Purchaser's site to take an image of the Purchaser. At step 38, the Purchaser's image is validated using the image recognition software 21. The current image is compared with the reference image of the valid cardholder stored in the image database at the Credit Card Company. At step 39, it is determined whether or not the validation resulted in a positive match of the Purchaser's image with the valid cardholder's reference image. If not, the method moves to step 41 where the transaction is halted. If the validation was positive, the method moves to step 42 where the Purchaser signs the whiteboard. The method then moves to FIG. 2B.

At step 43 of FIG. 2B, the Purchaser's signature is validated automatically by the Credit Card Company using the image recognition software 21. At step 44, it is determined whether or not the validation of step 43 resulted in a positive match of the Purchaser's signature image with the valid cardholder's reference signature image. If not, the method moves to step 45 where the transaction is halted. If the validation was positive, the method moves to step 46 where the transaction is approved. At step 47, a copy of the transaction including the Purchaser's signature is electronically stored and/or printed by at least the Credit Card Company. The multi-party SIP session is then terminated at step 48.

The invention provides three different levels of verification and validation of credit card transactions in electronic commerce. Preferably, the credit card information is verified first. Then, depending on the security level required by a particular transaction, or the type of transaction, both of the additional levels or just one additional level can be used. For example, the signature comparison (i.e., the electronic whiteboard) may be used by itself without the comparison of the purchaser's image.

The invention can also automate the validation process during face-to-face transactions (i.e., automatic identification validation and/or signature comparison). In this case, a two-party data session is established between the merchant and the credit card company. The most awkward part of the validation process for the merchant is having to ask the purchaser for a picture ID. Therefore, the automated image comparison may be used to eliminate this requirement. Additionally, although performing a signature comparison during a face-to-face transaction is usually not a problem, this part of the process can also be automated by performing the automated signature comparison.

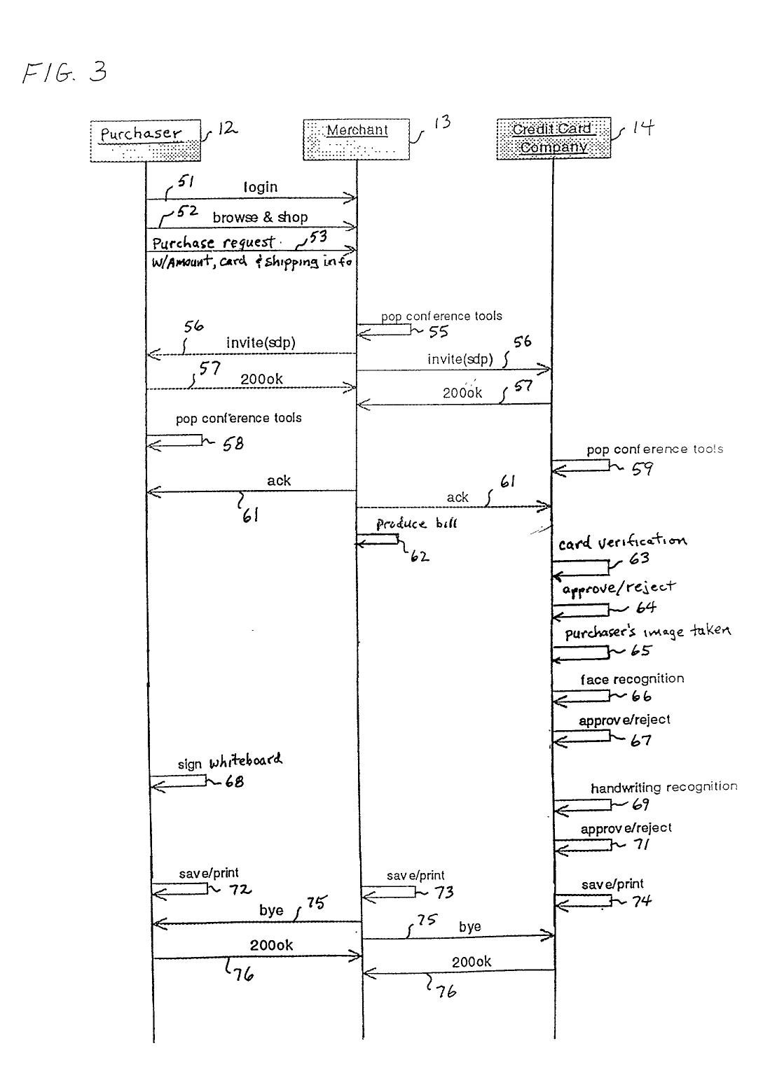

FIG. 3 is a signaling diagram illustrating the flow of messages between the parties in an electronic transaction when performing the preferred embodiment of the present invention. At step 51, the Purchaser logs in with the on-line Merchant, and at 52, browses and shops on the Merchant's Web site. When the Purchaser finishes shopping, a purchase request is submitted at 53 which may optionally include the amount of the purchase, credit card information, and the purchaser's shipping information. For repeat purchasers, the Merchant may have a purchaser database that contains credit card information and/or shipping information. At 55 the Merchant sets up the multi-party conference tools. This includes the video conferencing tool 15, the whiteboard application 17, and optionally the audio tool 16. A multi-party session is then established between the Purchaser, the on-line Merchant, and the Credit Card Company using, for example, a SIP multi-party conferencing tool. When SIP is utilized, the Merchant sends a SIP Invite message 56 to the Purchaser and the Credit Card Company, both of which respond with a SIP 200 OK message 57. The Purchaser then sets up the multi-party conference tools at 58, and the Credit Card Company sets up the multi-party conference tools at 59. The Merchant then sends an Acknowledgment message 61 to the Purchaser and the Credit Card Company.

At 62, the Merchant produces the bill in the multi-party SIP session for all the parties. At 63, the credit card information is verified by the Credit Card Company using normal procedures. If the credit card information is valid, the transaction is approved at 64 to proceed to the next level. If the information is not valid, the transaction is rejected. At step 65, the credit card company uses the Web camera at the Purchaser's site 12 to take an image of the Purchaser. At step 66, the Purchaser's image is validated by the Credit Card Company using the image recognition software 21. The Purchaser's image is compared with the reference image of the valid cardholder stored in the image database 23. At step 67, the transaction is either approved to proceed to the next level, or is rejected, depending on the results of the image comparison.

At step 68, the whiteboard application presents a signature block to the Purchaser who then signs the whiteboard. At 69, the image recognition software 21 automatically compares the Purchaser's signature to a reference image of the valid cardholder's signature stored in the signature image database 24. At step 71, the transaction is either approved, or is rejected, depending on the results of the signature image comparison. At steps 72, 73, and 74, a copy of the transaction including the Purchaser's signature is electronically stored and/or printed by at least the Credit Card Company. Steps are then taken to terminate the multi-party conference. For example, the Merchant may send a SIP Bye message 75 to the Purchaser and the Credit Card Company. The Purchaser and the Credit Card Company respond by sending a SIP 200 OK message 76 to the Merchant, thus terminating the SIP multi-party conference.

It is thus believed that the operation and construction of the present invention will be apparent from the foregoing description. While the system and method shown and described has been characterized as being preferred, it will be readily apparent that various changes and modifications could be made therein without departing from the scope of the invention as defined in the following claims.

What is claimed is:

1. A method of authorizing an electronic commerce transaction between a purchaser using a credit card, an on-line merchant, and a credit card company, said method comprising the steps of:
receiving by the merchant, a purchase request from the purchaser;
obtaining by the merchant, the purchaser's credit card information;
establishing a multi-party data session between the purchaser, the on-line merchant, and the credit card company;
producing a bill by the merchant in the multi-party data session, said bill including the purchaser's credit card information;
verifying the credit card information by the credit card company;
taking an image of the purchaser with a Web camera;
validating the purchaser's image by the credit card company;
utilizing a whiteboard application to obtain the purchaser's signature;
validating the purchaser's signature by the credit card company; and
approving the transaction upon positively verifying the credit card information and validating the purchaser's image and signature.

2. The method of authorizing an electronic commerce transaction of claim 1 wherein the step of validating the image by the credit card company includes the steps of:
storing in an image database, a processed image of a valid cardholder associated with the credit card; and
utilizing an image recognition program to compare the image of the purchaser with the stored image of the valid cardholder.

3. The method of authorizing an electronic commerce transaction of claim 1 wherein the step of validating the purchaser's signature by the credit card company includes the steps of:
storing in a signature image database, a processed image of a signature of a valid cardholder associated with the credit card; and
utilizing an image recognition program to compare the signature of the purchaser with the stored image of the valid cardholder's signature.

4. A method of authorizing an electronic commerce transaction between a purchaser using a credit card, an on-line merchant, and a credit card company, said method comprising the steps of:
receiving by the merchant, a purchase request from the purchaser;
obtaining by the merchant, the purchaser's credit card information;
establishing a multi-party data session between the purchaser, the on-line merchant, and the credit card company;
obtaining the purchaser's credit card information by the credit card company through the multi-party data session;
determining by the credit card company whether the credit card is valid;
utilizing a whiteboard application to obtain the purchaser's signature, upon determining that the credit card is valid;
determining by the credit card company whether the purchaser's signature is valid; and
approving the transaction upon determining that the signature is valid.

5. The method of authorizing an electronic commerce transaction of claim 4 wherein the step of determining by the credit card company whether the purchaser's signature is valid includes the steps of:
storing in a signature image database, a processed image of a signature of a valid cardholder associated with the credit card; and
utilizing an image recognition program to compare the signature of the purchaser with the stored image of the valid cardholder's signature.

6. The method of authorizing an electronic commerce transaction of claim 4 further comprising, after the step of determining by the credit card company whether the credit card is valid, the step of rejecting the transaction upon determining that the credit card is not valid.

7. The method of authorizing an electronic commerce transaction of claim 4 further comprising, after the step of determining by the credit card company whether the purchaser's signature is valid, the step of rejecting the transaction upon determining that the purchaser's signature is not valid.

8. The method of authorizing an electronic commerce transaction of claim 4 further comprising the steps of:
taking an image of the purchaser with a Web camera; and
determining by the credit card company whether the purchaser's image is valid.

9. The method of authorizing an electronic commerce transaction of claim 8 wherein the step of determining by the credit card company whether the purchaser's image is valid includes the steps of:
storing in an image database, a processed image of a valid cardholder associated with the credit card; and
utilizing an image recognition program to compare the image of the purchaser with the stored image of the valid cardholder.

10. The method of authorizing an electronic commerce transaction of claim 8 further comprising, after the step of determining by the credit card company whether the purchaser's image is valid, the step of rejecting the transaction upon determining that the purchaser's image is not valid.

11. A system for authorizing an electronic commerce transaction between a purchaser using a credit card, an on-line merchant, and a credit card company, said system comprising:
a server associated with the merchant for receiving a purchase request from the purchaser, and for obtaining the purchaser's credit card information;
a packet data network that connects the purchaser, the merchant, and the credit card company in a multiparty data session;
a Web camera for taking an image of the purchaser in response to the purchaser sending the purchase request to the merchant;
a first database that stores valid credit card information, said valid credit card information being compared to the purchaser's credit card information to verify the purchaser's information; and
a second database that stores processed images of valid cardholders, said images of valid cardholders being compared to the image of the purchaser to validate the purchaser's image;
whereby the credit card company approves the transaction upon positively verifying the credit card information, and upon validating the purchaser's image.

12. The system for authorizing an electronic commerce transaction of claim 11 further comprising:
a whiteboard application for capturing an image of the purchaser's signature; and
a third database that stores processed images of valid cardholder signatures, said images of valid cardholder signatures being compared to the image of the purchaser's signature to validate the purchaser's signature.

13. A system for authorizing an electronic commerce transaction between a purchaser using a credit card, an on-line merchant, and a credit card company, said system comprising:
a server associated with the merchant for receiving a purchase request from the purchaser, and for obtaining the purchaser's credit card information;
a packet data network that connects the purchaser, the merchant, and the credit card company in a multiparty data session;
a whiteboard application for capturing an image of the purchaser's signature;
a first database that stores valid credit card information, said valid credit card information being compared to the purchaser's credit card information to verify the purchaser's information;
a second database that stores processed images of valid cardholder signatures; and
an image recognition program that validates the purchaser's signature by comparing the image of the purchaser's signature to an image of a valid cardholder's signature from the second database;
whereby the credit card company approves the transaction upon positively verifying the credit card information, and upon validating the purchaser's signature.

14. The system for authorizing an electronic commerce transaction of claim 13 wherein the packet data network includes a multicasting mechanism for establishing a multi-party data session between the purchaser, the merchant, and the credit card company in which information related to the transaction is sent to a multicast Internet Protocol (IP) address of a multicast group to which the purchaser, the merchant, and the credit card company belong.

15. A method of authorizing a face-to-face commercial transaction between a purchaser using a credit card and a merchant, said method comprising the steps of:
receiving by the merchant, a purchase request from the purchaser;
obtaining by the merchant, the purchaser's credit card information;
establishing a data link between the merchant and a credit card company;
sending the credit card information to the credit card company;
verifying the credit card information by the credit card company;
taking an image of the purchaser with a Web camera;
validating the purchaser's image; and
approving the transaction by the credit card company upon positively verifying the credit card information and validating the purchaser's image.

16. The method of authorizing a face-to-face commercial transaction of claim 17 further comprising the steps of:
utilizing a whiteboard application to obtain the purchaser's signature;
validating the purchaser's signature; and
approving the transaction by the credit card company upon positively validating the purchaser's signature.

17. A system for authorizing a face-to-face commercial transaction between a purchaser using a credit card and a merchant, said system comprising:
a data link between the merchant and a credit card company for sending the purchaser's credit card information from the merchant to the credit card company;
a first database of valid credit card information for verifying the purchaser's credit card information;
a Web camera for taking an image of the purchaser;
a second database of processed images of valid cardholders for validating the purchaser's image; and
an image recognition program for validating the purchaser's image by comparing the purchaser's image to a processed image of a valid cardholder from the second database;
whereby the credit card company approves the transaction upon positively verifying the credit card information and validating the purchaser's image.

18. A method of authorizing an electronic commerce transaction between a purchaser using a credit card, an on-line merchant, and a credit card company in which the merchant receives a purchase request from the purchaser and obtains the purchaser's credit card information, and the credit card company verifies the credit card information, said method characterized by the steps of:
establishing a multi-party data session between the purchaser, the on-line merchant, and the credit card company;
taking an image of the purchaser with a Web camera;
validating the purchaser's image by the credit card company utilizing an image recognition program and a database of valid cardholder images;
obtaining the purchaser's signature with a whiteboard application;
validating the purchaser's signature by the credit card company utilizing the image recognition program and a database of valid cardholder signatures; and
approving the transaction by the credit card company upon positively verifying the credit card information and validating the purchaser's image and signature.
